(19) United States
(12) Patent Application Publication
(10) Pub. No.: US 2008/0092896 A1
(43) Pub. Date: Apr. 24, 2008

(54) Apparatus and methods for diet and weight control by suppressing the sense of smell and taste

(76) Inventor: Milton S. Jackson, Louisville, KY (US)

Correspondence Address: KIRTON AND MCCONKIE, 60 EAST SOUTH TEMPLE,, SUITE 1800, SALT LAKE CITY, UT, 84111, US

(21) Appl. No.: 11/247,706

(22) Filed: Oct. 11, 2005

(51) Int. Cl. A61G 10/00

(52) U.S. Cl. 128/206.11

(57) ABSTRACT

This invention comprises apparatus and methods for diet and weight control by altering the senses of smell and taste. The prophylactic hinders odoriferous molecules from reaching smell receptors in the nose. The loss of smell, appetite, and taste caused by apparatus and methods effectively decreases the appetite of an individual, enabling a user to eat less and lose weight.

### RELATED APPLICATION

This application is a continuation-in-part application of U.S. patent application Ser. No. 10/640,508, filed on Aug. 12, 2003, which claims the benefit of U.S. Provisional Application Ser. No. 60/403,066 filed on Aug. 11, 2002.

### BACKGROUND OF THE INVENTION

1. Field of the Invention

The present invention relates to diet and weight control. More particularly, the present inversion relates to an apparatus and method for diet and weight control by altering the senses of smell and, consequently, taste.

2. Background and Related Art

Obesity is a major healthcare issue. According to the National Center for Health Statistics (http://www.cdc.gov/nchs/), approximately 64 percent of adults in the United States age 20 years or older are obese or overweight. Many children and teenagers also struggle with weight problems. Obesity is one of the most important health issues in the world today because of its prevalence and close relationship to other health issues such as hypertension, diabetes, strokes, heart diseases, pulmonary diseases, cancers, orthopedic problems (e.g., back, hip, and knee pain), and many other serious and debilitating diseases. Obesity and related conditions cost Americans tens of billions of dollars annually and shorten peoples' life spans.

Obesity also impacts a person's quality of life. For instance, a person's general activity, exercise tolerance, and the ability to perform physical work are functions of weight. A person's self esteem is also often related to one's physical appearance. As a result, people spend millions of dollars on clothing, accessories, and cosmetics, often in order to look better.

A person's weight is dictated by a simple physical relationship between his/her inputs (food) and outputs (metabolism, growth, and exercise). Too much input or too little output, or a combination of both, can produce weight gain. Generally, if a person's input decreases, he/she loses weight.

Hunger and appetite are related to many factors including smells, tastes, habits, social issues, time issues, and activity levels. Taste is experienced through inputs from both the tongue and nose. In a general sense, a person's tongue enables one to feel the texture of food and to tell whether food is sweet, salty, sour, or bitter. While a person's nose enables one to experience and differentiate between roughly 10,000 different odors. The combination of inputs from the tongue and nose enables the brain to trigger glands, releasing hormones that stimulate or suppress hunger. Since the tongue is limited to sensing only the texture, sweetness, saltiness, sourness, and bitterness of food, a person's nose plays a very central role to the taste experience and development of appetite relative to the tongue.

### SUMMARY OF THE INVENTION

The object of the present invention is to help one diet or control their caloric intake by altering the sense of smell and thereby limiting or altering appetite and the taste experience. In general terms, the apparatus is a prophylactic that shields receptors in the nose from receiving odor molecules that can trigger one's appetite. More specifically, the prophylactic blocks odors that would otherwise trigger signals to the brain via the olfactory nerves to stimulate hunger or the taste experience. One aspect of the present invention is a patch that attaches inside the naval cavity blocking smell receptors from receiving food emitted molecules or light volatile chemicals that float through the air into one's nose. Another aspect of the present invention is that the prophylactic can be a semi-permeable membrane that blocks a percentage of air/molecule flow, thus reducing the sense of smell while still allowing a percentage of air to pass through the membrane. Furthermore, the patch membrane, or shield can be applied in a number of ways including self adhesion, friction or sutures.

The loss of smell caused by the apparatus effectively decreases the appetite of an individual, encouraging the individual to eat less and therefore loose weight.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE SEVERAL VIEWS OF THE DRAWINGS

The objects and features of the present invention will become more fully apparent from the following description and appended claims, taken in conjunction with the accompanying drawing. Understanding that the drawing depicts only typical embodiments of the invention and is, therefore, not to be considered limiting of its scope, the invention will be described and explained with additional specificity and detail through the use of the accompanying drawing in which:

FIG. 1 shows a prophylactic device in use.

### DETAILED DESCRIPTION OF THE INVENTION

The present invention relates to diet and weight control. More particularly, the present invention relates to apparatus and methods for diets and weight control by reducing the sense of smell to reduce appetite.

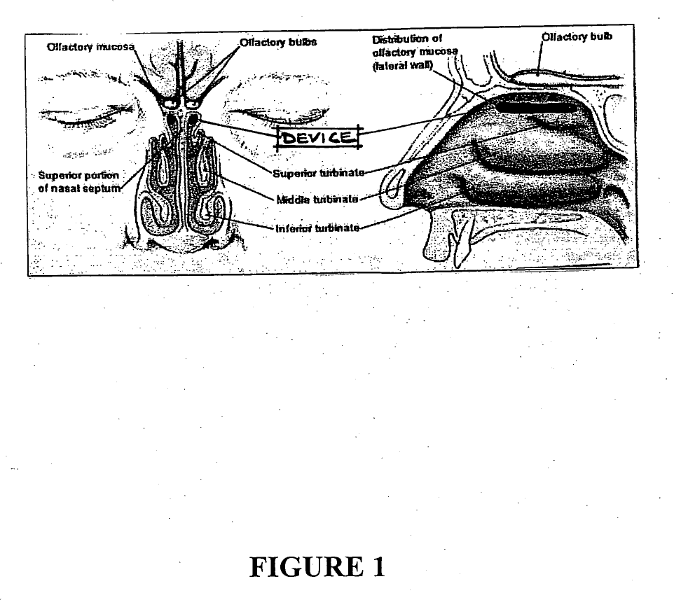

In the disclosure and in the claims, the term “prophylactic” shall refer to a non-toxic patch, barrier, shield, or membrane that is capable of being placed inside the nasal cavity to reduce access by odoriferous molecules to smell receptors. Such a prophylactic is shown in FIG. 1, illustrating placement of the prophylactic inside the nasal cavity. The present invention can be described by the following examples.

### EXAMPLE 1

An individual purchases a self-application kit that includes a nasal prophylactic and an application rod to apply the prophylactic to a position blocking smell receptors. The kit also includes detailed instructions on how the procedure is preformed. The prophylactics can range in sizes depending on the coverage needed for a particular patient. Additionally the mechanism that holds the prophylactic in the nasal cavity can be adhesive, pressure-fit, or an equivalent thereof. In this example, the prophylactic is almost completely impermeable to odor molecules; thus, odor molecules are blocked from reaching smell receptors (or olfactory nerves) and, consequently, appetite and the enjoyment of food is greatly reduced because the sense of smell is almost completely lost.

### EXAMPLE 2

An individual goes to a doctor where a prophylactic is secured in the nasal cavity to block smells from reaching smell receptors (or the olfactory nerves), resulting in a decrease in appetite and taste. In this example, the prophylactic is a semi-permeable membrane that allows certain sized molecules, or a resulting percentage of molecules (i.e., 5%), to pass through the patch to reach smell receptors. In this way, the prophylactic is proportionally effective in reducing appetite and taste, while allowing some sense of smell. The prophylactic can be made of any substance with the desired permeability, such as a plastic, polymer, or starch. In this example, the size and shape of the prophylactic can be varied by the doctor to more effectively block an individual's smell receptors. When the prophylactic is no longer needed or desired, the doctor can simply remove it in an outpatient procedure. Alternatively, the sutures can be made out of a substance that will naturally dissolve in the body after a certain period of time.

Thus, as discussed herein, the embodiments of the present invention embrace apparatus and methods for diet and weight control by altering or prohibiting the sense of smell and its influence on the taste and appetite. Aspects illustrated in one example are capable of implementation in other examples while remaining within the scope of the present invention.

The present invention may be embodied in other specific forms without departing from the spirit or essential characteristics of the invention. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. An apparatus for suppressing hunger, comprising a prophylactic capable of being secured in a nasal cavity and blocking smells from reaching smell receptors.

2. The apparatus of claim 1, wherein the prophylactic is a non-toxic membrane.

3. The apparatus of claim 2, wherein the membrane is a semi-permeable membrane that allows some molecules to pass through the membrane while blocking others.

4. The apparatus of claim 2, wherein the membrane is made of a substance designed to dissolve in the nasal cavity over time.

5. The apparatus of claim 1, wherein the prophylactic is made out of a material chosen from the group consisting of plastic, starch, and polymer.

6. The apparatus of claim 1, further comprising an application rod that is capable of holding the prophylactic, allowing a user to maneuver the prophylactic to a desired location in the nose, and allowing the user to release the prophylactic at the desired location in the nose.

7. A method for diet and weight control comprising the step of:
Applying to the interior of a nose a prophylactic that physically blocks smells from reaching smell receptors in the nose.

8. The method of claim 7, wherein the step of applying the prophylactic is performed in outpatient surgery

9. The method of claim 7, wherein the step of applying the prophylactic is preformed with an application rod.

10. The method of claim 7, wherein the step of applying the prophylactic consists of placing a patch over the smell receptors in the nose.

11. The method of claim 7, further comprising the step of removing the prophylactic from the interior of the nose.

12. A method for diet and weight control comprising the steps of:
Applying a prophylactic to the interior of a nose;
blocking molecules with the prophylactic from reaching smell receptors in the nose, resulting in a reduced sense of smell;
reducing the sense of taste and appetite through the reduction of the sense of smell caused by the prophylactic; and
encouraging weight loss through the reduction in the sense of taste and appetite caused by the prophylactic.

13. The method of claim 12, further comprising the step of removing the prophylactic from the interior of the nose.
